(19) United States
(12) Patent Application Publication
(10) Pub. No.: US 2007/0287507 A1
(43) Pub. Date: Dec. 13, 2007

(54) System and method for automatically toggling the alert of a wireless device

(75) Inventors: Thomas J. Aton, Dallas, TX (US); Beatrice Rapley Aton, Dallas, TX (US)

Correspondence Address: TEXAS INSTRUMENTS INCORPORATED, P O BOX 655474, M/S 3999, DALLAS, TX, 75265, US

(73) Assignee: TEXAS INSTRUMENTS INCORPORATED

(21) Appl. No.: 11/450,447

(22) Filed: Jun. 12, 2006

(51) Int. Cl. H04B 1/38; G08B 5/22; G08B 7/00

(52) U.S. Cl. 455/567; 340/691.5; 340/7.58

(57) ABSTRACT

A system and method for communicating with a wireless device to automatically toggle the alert. The control station automatically transmits at least one signal to the wireless device, which instructs the wireless device to use a silent alert. The control station can also include a database for storing identifiers of wireless devices having users who must remain available, allowing those wireless devices to use a tactile alert instead of a silent alert. The control station can automatically instruct the wireless device to use a silent alert, a tactile alert, or an audible alert depending upon the time of day.

### FIELD OF THE INVENTION

The present invention is directed to a system and method for communicating with any mobile or wireless device and, specifically, to a system and method for automatically toggling the alert of any mobile or wireless device.

### BACKGROUND OF THE INVENTION

Mobile devices and wireless communication devices use various alert techniques to indicate to a user that an incoming desired signal, such as an incoming call, has been received. For example, a mobile phone alerts the user with a ring tone or vibration when an incoming call signal is received, and a pager alerts the user when an incoming page signal is received. Generally, these alert techniques include audible alerts, silent alerts, visual alerts, and tactile alerts.

The audible alert generator is typically implemented with an acoustic transducer, i.e. a speaker, sometimes known as a ringer. A visual alert generator is typically implemented with a display or a separate indicator, such as a flashing light. A tactile alert generator is typically implemented with an axially offset counter-weight driven by a motor in the wireless device to cause a vibrating sensation.

The sound produced by audible alert generators, however, can be disturbing to others in certain environments, such as during a meeting or movie. In such environments, it is considered preferable to use a silent alert. To eliminate intrusive noise from wireless devices, operators of some venues hosting a performance or event have resorted to “jammers,” which overpower or override all radio transmission in the frequency bands for a wireless device. These jammers prevent any wireless devices from “ringing” within a given region (for example, a theater or the sanctuary of a cathedral). Unfortunately, such jammers may not be appropriate for those individuals who must remain in contact, such as doctors on call or emergency personnel.

Accordingly, it may be desirable to provide methods and systems that prevent mobile or wireless devices from making audible noise within a given region, yet allowing those mobile or wireless devices to remain in contact with their respective communication networks.

### SUMMARY

In accordance with the invention, there is disclosed a control station configured to control alerts used by wireless devices within an area, said control station comprising: a receiver configured to receive signals from a wireless device; a processor configured to identify the wireless device based on the received signals and determine an alert to be used by the wireless device; and a transmitter configured to transmit to the wireless device a signal that instructs the wireless device to use a selected type of alert while the wireless device is within the area.

In various aspects, there is also disclosed a method of controlling alerts used by a wireless device within an area, said method comprising: identifying the wireless device when it is in proximity to the area; selecting an alert to be used by the wireless device based on the identify of the wireless device; and transmitting to the wireless device at least one signal that instructs the wireless device to use the selected alert when the wireless device is within the area.

In various aspects, there is also disclosed a system comprising a wireless device configured to provide a plurality of alerts; and a control station comprising a receiver for receiving signals from the wireless device, a processor configured identify the wireless device based on the received signals and select an alert for the wireless device, and a transmitter for transmitting to the wireless device at least one signal that instructs the wireless device to use a silent type of alert, an audible type of alert, a tactile type of alert, or a visual type of alert.

In various aspects, there is also disclosed a wireless device configured to provide a plurality of types of alerts and change its alerts, said wireless device comprising a set of alert generators configured to provide alerts; a receiver configured to receive a control signal; and a processor configured to interpret the control signal and automatically select a set of alerts based on the control signal.

Additional features of the invention will be set forth in part in the description which follows, and in part will be obvious from the description, or may be learned by practice of the invention. The features of the invention will be realized and attained by means of the elements and combinations particularly pointed out in the appended claims. It is to be understood that both the foregoing general description and the following detailed description are exemplary and explanatory only and are not restrictive of the invention, as claimed.

### BRIEF DESCRIPTION OF THE DRAWINGS

The accompanying drawings, which are incorporated in and constitute a part of this specification, illustrate embodiments of the invention and together with the description, serve to explain the principles of the invention.

FIG. 1 depicts a block diagram of an exemplary wireless device 100, consistent with systems and methods consistent with the present invention;

FIG. 2 depicts a block diagram of an exemplary control station 200, consistent with systems and methods consistent with the present invention;

FIG. 3 depicts a flow diagram of an exemplary automatic wireless device alert toggle process, in accordance with systems and methods consistent with the present invention; and

FIG. 4 depicts a block diagram of an exemplary system involving hands-free usage of a wireless device, consistent with systems and methods consistent with the present invention.

### DESCRIPTION OF THE EMBODIMENTS

Embodiments of the present invention provide a way of automatically controlling and toggling the alerts used by mobile or wireless devices within an area. Such devices may be, for example, a mobile phone, a personal digital assistant, a pager, and the like. A control station detects when one or more wireless devices are within proximity of an area and may send various control signals that instruct the wireless devices to use a particular type of alert, such as a silent alert, or instructs the wireless devices to disable their alerts. The control station may include a database or access a remote database for storing identifiers of wireless devices having users who must remain available.

The control station may automatically transmit at a specific time of day at least one signal to a wireless device to instruct the wireless device to use various types of alerts, such as a silent alert, a tactile alert, a visual alert, or an audible alert. For example, the control station can automatically transmit at least one signal to the wireless device instructing it to use an audible alert during daytime hours and a silent alert during evening hours. As another example, embodiments of the present invention may be employed at a user's residence to automatically toggle the mobile device to use an audible alert (and thus ensure that the mobile device can be readily heard while the user is at home).

The control station can receive an indication over a network from an accessory device, indicating whether the wireless device is attached to the accessory device for hands-free or other type of use. The control station can then transmit at least one signal to the wireless device instructing it to use an audible alert when the wireless device is attached or within a controlling region to the accessory device and a silent alert when the wireless device is not attached or coupled.

Reference will now be made in detail to the exemplary embodiments of the invention, examples of which are illustrated in the accompanying drawings. Wherever possible, the same reference numbers will be used throughout the drawings to refer to the same or like parts.

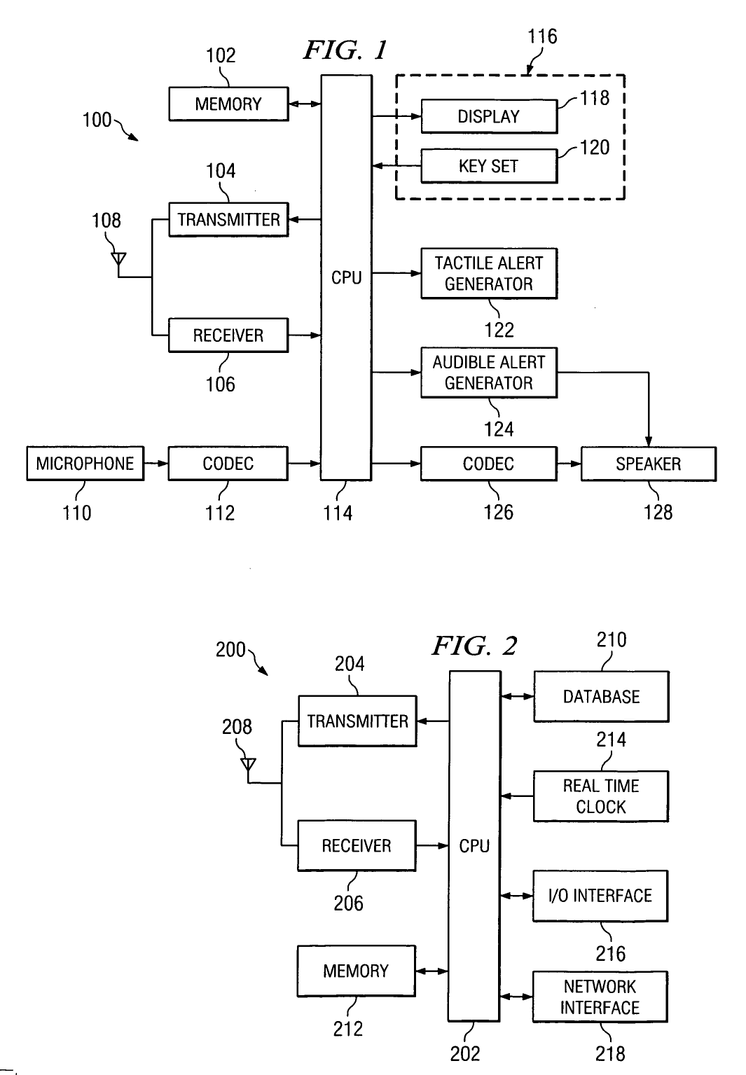

FIG. 1 depicts a block diagram of an exemplary wireless device 100, consistent with systems and methods consistent with the present invention. Such devices are well known to those skilled in the art and any form of wireless device may be appropriately employed in embodiments of the present invention. Typically, wireless device 100 includes a central processing unit 114 connected to a user interface 116. User interface 116 can include a display 118 and a key set 120, both connected to central processing unit 114. The wireless device 100 can be a cellular radiotelephone, a cordless radiotelephone, a personal digital assistant, a portable game device, a paging/messaging device, or any other portable device that communicates with another device (i.e. a one-way or two-way communications device), and “wireless device” as used herein refers to each of these and their equivalents. Wireless device 100 may also include a microphone 110 and speaker 128 connected to central processing unit 114 through codifier/decodifier (CODEC) 112 and 126, respectively.

Key set 120 is implemented using any suitable means, such as a push-button keypad, a touch screen, or the like. Display 118 is implemented using a suitable commercially available apparatus, such as liquid crystal display (LCD), a light emitting diode (LED) display, or the like. Central processing unit 114 is implemented using one or more suitable microcontrollers, microprocessors, or digital signal processors, such as a universal phone processor manufactured by Texas Instruments. Central processing unit 114 may be programmable where it includes a programmable storage device (not shown) tangibly embodying a program of instructions executable by the central processing unit. In the alternative, central processing unit 114 may be implemented using a microcontroller coupled to a separate programmable storage device, such as a digital signal processor, that tangibly embodies a program of instructions executable by central processing unit 114.

A memory 102 for storing information to determine the type of alert is connected to the central processing unit 114. One skilled in the art will recognize that memory 102 may store information related to a plurality of alerts of various forms. For example, wireless device 100 may include a tactile alert generator 122 and an audible alert generator 124 to alert a user of an incoming call. In addition wireless device 100 can alert a user of an incoming call through visual means such as through a display mechanism, such as display 118 or a flashing indicator light. Tactile alert generator 122 can be implemented using a transducer; a motor (not shown) which drives an offset weight (not shown) to rotate thereby creating a vibration; or any other suitable means. All of the alert generators, such as alert generators 122 and 124, may be connected to the central processing unit 114.

In addition, central processing unit 114 may be configured to alert a device coupled to wireless device 100. For example, wireless device 100 may be coupled to a wireless accessory device, such as a headset, using well known technologies, such as BLUETOOTH™. Accordingly, central processing unit 114 may be configured to alert various devices, such as BLUETOOTH devices, which are within proximity to wireless device 100.

The wireless device transceiver includes a transmitter 104 and a receiver 106. In general, the central processing unit 114 outputs signals to transmitter 104, which modulates the signals for transmission via antenna 108. Signals detected by antenna 108 are demodulated by receiver 106, and the resulting signal is input to central processing unit 114. In the alternative, central processing unit 114 may demodulate the signal. Accordingly, central processing unit 114 outputs these signals to the speaker 128 or uses this signal in its control processes.

FIG. 2 depicts a block diagram of an exemplary control station 200, consistent with systems and methods consistent with the present invention. Control station 200 includes a central processing unit 202, I/O interface 216, a memory 212, and a network interface 218. Central processing unit 202 executes instructions associated with applications contained in memory 212 and transmits results to other subsystems in control station 200. Central processing unit 202 is implemented using one or more suitable microcontrollers, microprocessors, or digital signal processors, such as a universal phone processor like those manufactured by Texas Instruments. Alternatively, central processing unit 202 may be implemented using a microcontroller coupled to a separate programmable storage device, such as a digital signal processor, that tangibly embodies a program of instructions executable by central processing unit 202. I/O interface 116 is an interface used to couple control station 200 with devices such as a keyboard, a mouse, a display device, and any other I/O device useful in operating and managing control station 200 as is understood by one of skill in the art. An optional network interface 218 can be used to communicate with a network (not shown), which can be any network or networks including the Internet, intranets, telephony networks, and other networks compatible with a networking protocol such as TCP/IP.

Control station 200 communicates with wireless device 100 using transmitter 204, receiver 206, and antenna 208. In general, the central processing unit 202 outputs signals to transmitter 204, which modulates the signals for transmission via antenna 208. Signals detected by antenna 208 are demodulated by receiver 206, and the resulting signal is input to central processing unit 202. In the alternative, central processing unit 202 may demodulate the signal. Communication with wireless device 100 can occur through any suitable communication scheme including code division multiple access (CDMA), Time Division Duplex (TDD), or any other communication scheme suitable for communication with wireless device 100.

Control station 200 can also include database 210 for storing an identifier, such as a telephone number, for certain wireless devices that require special signals to instruct the wireless devices to generate an audible or tactile alert instead of a silent alert. Central processing unit 202 can access information from database 210 to determine whether a wireless device should receive special signals as described below. Database 210 stores database entries that can be accessed through a database protocol such as, in one embodiment, Structured Query Language (SQL). For example, a wireless device user could register the device by providing an identifier for the device, such as a telephone number, to an operator of control station 200. The wireless device user could also register the device using a data network, such as the Internet. For example, the user may use the wireless device (or another device) to browse to a server coupled to the Internet or some other well known type of network. The user may register at the time of purchasing the wireless device 100 or at some convenient time later. Some users may be entitled to a privileged or special status. For example, health professionals, law enforcement officials, government officials, and the like may be granted special status such that their wireless device is alerted in an appropriate manner. Of course, in some embodiments, these types of users may be required or asked to present authentication of their occupation for entitlement to a special status. The wireless device's identifier can then be stored as an entry in database 210. In one embodiment, control station 200 also includes a real time clock 214, which allows a user to program control station 200 to send specific signals during certain times as is described below.

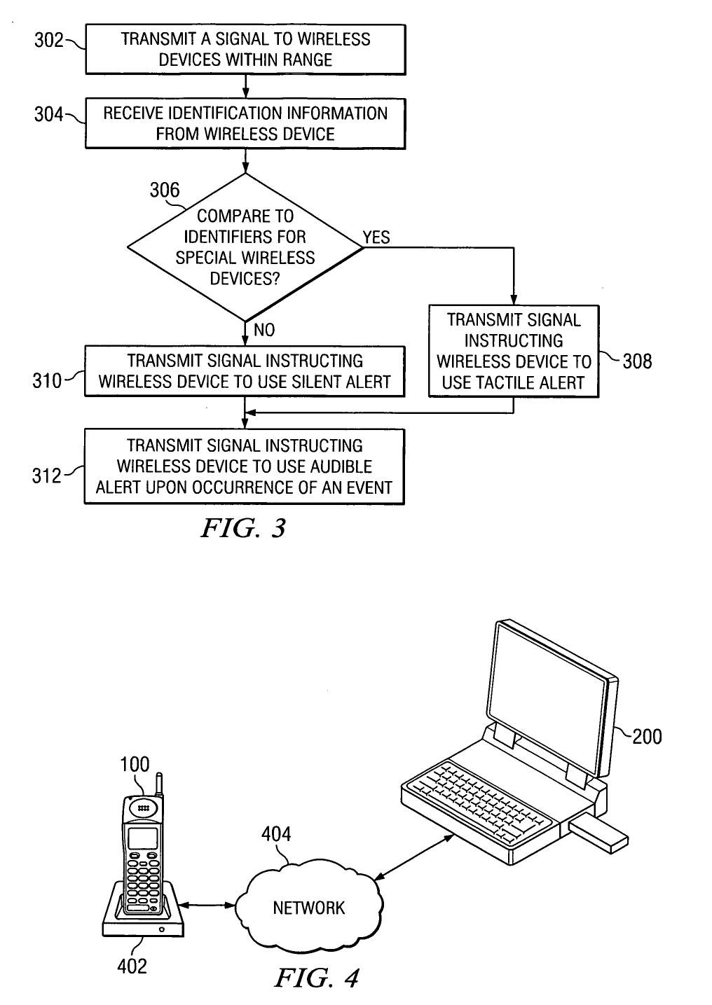

FIG. 3 depicts a flow diagram of an exemplary automatic wireless device alert toggle process, in accordance with systems and methods consistent with the present invention. The flow diagram will be described with reference to the embodiment of the systems depicted in FIGS. 1 and 2. First, control station 200 opens a control channel with a wireless device by transmitting (Step 302) a signal from transmitter 204 to any wireless device within range. Unlike typical jammers, embodiments of the present invention provide a specific digital control signal that instructs any wireless device to configure its alerts in an appropriate manner rather than overwhelming the wireless device. The range of the control region by control station 200 can be determined by the strength of the signal from antenna 208. For example, antenna 208 may be sized to control wireless devices within a building or within a radius of 30 meters. Of course, the size and configuration of the control region surrounding antenna 208 is at the discretion of the design requirements of control station 200. When wireless device 100 is within range, it identifies itself by sending identification information, such as, its telephone number, its electronic serial number, and the like.

Central processing unit 202 receives (Step 304) the identification information from wireless device 100 via receiver 206 and, in one embodiment, compares (Step 306) it with the entries stored in database 210. As described above, entries in database 210 are identifiers, such as telephone numbers, for wireless devices that should receive special signals, which instruct the wireless devices to use an audible or tactile alert. Alternatively, central processing unit 202 may access a remote database through a network, such as a local area network, or the Internet.

If the identification information from wireless device 100 matches an entry in database 210, central processing unit 202 can transmit (Step 308) a control signal to wireless device 100 instructing wireless device 100 to use a specific type of alert, such as an alert provided by tactile alert generator 122 to alert a user of an incoming call. Of course, the control signal to wireless device 100 may instruct it to use other forms of alert. For example, the control signal may instruct wireless device 100 to use only silent types of alerts for incoming telephone calls, but allow other forms of alert for incoming text messages or emails. As noted above, central processing unit 202 may also instruct wireless device 100 based on the status of the user. For example, special status users, such as health professionals and law enforcement officials, may continue to receive audible alerts anywhere within the control region of control station 200. As shown in FIG. 1, receiver 106 in wireless device 100 receives this control signal and central processing unit 114 stores an instruction in memory 102 for using the selected type of alert, such as the selected alert by tactile alert generator 122 to alert a user of an incoming call. Of course, any type of alert may be selected by central processing unit 114 of wireless device 100. In addition, control station 200 may simply specify a class or type of alert in its control signal and allow wireless device 100 to select one or more alerts within that class of alert. Wireless device 100 may also be instructed to provide a change status alert, such as a short “chirp” or vibrate, to indicate to the user that its alert configuration has been toggled.

If identification information from wireless device 100 does not match an entry in database 210, central processing unit 202 transmits (Step 310) a control signal to wireless device 100 instructing wireless device 100 to use a default type of alert, such as a silent alert, or a visual alert on display 118 to alert a user of an incoming call. Wireless device 100 may also be instructed to provide a change status alert, such as a short “chirp” or vibrate, to indicate to the user that its alert configuration has been modified.

In one embodiment, control station 200 can transmit (Step 312) a control signal to re-activate the alert of wireless device 100 upon occurrence of an event. For example, at a specified time, such as the end of a performance or event, control station 200 can automatically send out a control signal to instruct wireless device 100 to allow an audible alert or any alert desired by the user.

Through I/O interface 216, an operator of control station 200 can use real time clock 214 to program control station 200 to send a signal at a specified time. For example, control station 200 can transmit a signal to wireless device 100 to use a silent alert, or a visual alert on display 118, during evening hours and transmit a signal instructing wireless device 100 to use only an audible type of alert during daytime hours. Control station 200 can also be programmed remotely through a network using network interface 218, as is well understood by those skilled in the art.

FIG. 4 depicts a block diagram of an exemplary system involving hands-free usage of a wireless device, consistent with systems and methods consistent with the present invention. The system depicted in FIG. 4 is applicable to an environment, such as an automobile, because the user will only become alerted to a call when the wireless device is configured for hands-free use. FIG. 4 depicts an embodiment in which control station 200 is connected to a network 404, which is connected to an accessory device 402 that allows hands-free usage of wireless device 100. Accessory device 402 can be any “cradle” or headset, such as a BLUETOOTH device, that provides for hands-free usage as is understood by those skilled in the art. When wireless device 100 is attached or coupled to accessory device 402, accessory device 402 can send a signal to network 404 indicating to control station 200 that wireless device 100 has been attached or coupled to accessory device 402. Control station 200 receives this indication from network 404 through network interface 218 (FIG. 1) and, upon receiving this signal, control station 200 can automatically transmit a signal to instruct wireless device 100 to use a specific type of alert, such as an audible alert. Similarly, when wireless device 100 is removed from accessory device 402, accessory device 402 sends a signal to network 404 alerting control station 200, which can then transmit a signal to instruct wireless device 100 to use another type of alert, such as a silent alert.

Other embodiments of the invention will be apparent to those skilled in the art from consideration of the specification and practice of the invention disclosed herein. For example, many users often toggle their wireless devices to use a silent alert while away or at work. However, when returning home, these users often forget to toggle their wireless device to use an audible alert, and thus, may miss one or more incoming calls. Accordingly, embodiments of the present invention may be used to toggle a wireless device from silent alerts to audible alerts when a user enters their home. Nonetheless, it is intended that the specification and examples be considered as exemplary only, with a true scope and spirit of the invention being indicated by the following claims.

What is claimed is:

1. A control station configured to control alerts used by wireless devices within an area, said control station comprising:
a receiver configured to receive signals from a wireless device;
a processor configured to identify the wireless device based on the received signals and determine an alert to be used by the wireless device; and
a transmitter configured to transmit to the wireless device a signal that instructs the wireless device to use a selected type of alert while the wireless device is within the area.

2. The control station of claim 1 wherein the transmitter is configured to transmit a signal that instructs the wireless device to use a silent type of alert.

3. The control station of claim 1 wherein the transmitter is configured to transmit a signal that instructs the wireless device to use an audible type of alert.

4. The control station of claim 1 wherein the transmitter is configured to transmit a signal that instructs the wireless device to suppress its alerts.

5. The control station of claim 1 further comprising a database that indicates wireless devices that have previously registered with the control station.

6. The control station of claim 1, wherein the control station is configured to remotely access a database that indicates wireless devices that have previously registered with the control station.

7. The control station of claim 4, wherein the processor is configured to determine if the wireless device is one of the previously registered wireless devices and determine a type of alert based on whether the wireless device was previously registered.

8. The control station of claim 4, wherein the processor is configured to determine if the wireless device is one of the previously registered devices and select a silent alert when the wireless device has not been previously registered.

9. The control station of claim 4, wherein the receiver is configured to receive electronic serial identification information from the wireless device.

10. The control station of claim 4, wherein the receiver is configured to receive user identification information from the wireless device.

11. The control station of claim 1, wherein the transmitter is configured to transmit signals at pre-programmed respective times for instructing the wireless device to use a silent type of alert, a tactile type of alert, a visual type of alert, or an audible type of alert.

12. A method of controlling alerts used by a wireless device within an area, said method comprising:
identifying the wireless device when it is in proximity to the area;
selecting an alert to be used by the wireless device based on the identify of the wireless device; and
transmitting to the wireless device at least one signal that instructs the wireless device to use the selected alert when the wireless device is within the area.

13. The method of claim 10 wherein the at least one signal is configured to instruct the wireless device to use an audible alert.

14. The method of claim 10 wherein the at least one signal is configured to instruct the wireless device to use a tactile alert.

15. The method of claim 10 further comprising, storing a set of identifiers corresponding to a set of wireless devices that have been registered for the area.

16. The method of claim 10 further comprising:
determining if the wireless device is one of the set of registered wireless devices; and
transmitting to the wireless device at least one signal that instructs the wireless device to use a silent alert.

17. The method of claim 14 further comprising:
determining if the wireless device is not one of the set of registered wireless devices; and
transmitting to the wireless device at least one signal that instructs the wireless device to use a tactile alert.

18. The method of claim 14 further comprising:
receiving electronic serial number identification information from the wireless device.

19. The method of claim 16 further comprising:
receiving user identification information from the wireless device.

20. The method of claim 11 further comprising:
transmitting, upon an event, to the wireless device at least one signal that instructs the wireless device to use an audible alert, a tactile alert, or a silent alert.

21. The method of claim 18, wherein the event is a time of day.

22. The method of claim 18, wherein the event is an indication that the wireless device has been placed in an accessory device.

23. A system comprising:
a wireless device configured to provide a plurality of alerts; and
a control station comprising a receiver for receiving signals from the wireless device, a processor configured identify the wireless device based on the received signals and select an alert for the wireless device, and a transmitter for transmitting to the wireless device at least one signal that instructs the wireless device to use a silent type of alert, an audible type of alert, a tactile type of alert, or a visual type of alert.

24. The system of claim 21, further comprising an accessory device configured to hold the wireless device and send an indication to the control station when the wireless device is connected to the accessory device.

25. A wireless device configured to provide a plurality of types of alerts and change its alerts, said wireless device comprising:
a set of alert generators configured to provide alerts;
a receiver configured to receive a control signal; and
a processor configured to interpret the control signal and automatically select a set of alerts based on the control signal.

26. The wireless device of claim 25, wherein processor is configured to automatically select at least one of a silent type of alert, an audible type of alert, a tactile type of alert, or a visual type of alert based on the control signal.
